(19) United States
(12) Patent Application Publication
(10) Pub. No.: US 2001/0014442 A1
(43) Pub. Date: Aug. 16, 2001

(54) Essential constituent and method of use for maintaining hair coloration or reversing hair discoloration

(76) Inventors: James G. Morris, Davis, CA (US); Quinton R. Rogers, Davis, CA (US)

Correspondence Address: COUDERT BROTHERS, Suite 3300, 4 Embarcadero Center, San Francisco, CA, 94111, US

(21) Appl. No.: 09/776,216

(22) Filed: Feb. 2, 2001

Related U.S. Application Data
(63) Continuation-in-part of application No. 09/501,548, filed on Feb. 9, 2000.

(51) Int. Cl. A01N 1/00; A01N 1/02

(52) U.S. Cl. 435/1.1; 514/2; 424/441

(57) ABSTRACT

A consumable product utilized to maintain and restore hair color comprises a substrate and an effective amount of a directly available amino acid (in pure or diluted form) (obtainable, usually upon digestion or hydrolysis, from peptides, polypeptides, proteins, and derivatives thereof such as acyl and amide forms) wherein the directly available amino acid is selected from the group consisting of tyrosine, phenylalanine and mixtures thereof. Included is a related method for maintaining and restoring hair color that comprises the steps of adding an effective amount of a directly available amino acid selected from the group consisting of tyrosine, phenylalanine and mixtures thereof to a consumable product to produce a supplemented consumable. An efficacious amount of the supplemented consumable may be fed to an animal to maintain and restore hair color in the animal.

### CROSS-REFERENCE TO RELATED APPLICATIONS

This is a continuation-in-part application of copending application having Ser. No. 09/501,548, filed Feb. 9, 2000, fully incorporated herein by reference thereto and is of common assignment herewith.

### BACKGROUND OF THE INVENTION

1. Field of the Invention

A food product or consumable product and method of use are provided that prevent and reverse hair discoloration. More specifically, the amino acids tyrosine or phenylalanine, especially tyrosine, have been found as essential diet constituents for desirable hair coloration in any animal, particularly in cats and dogs.

2. Description of Related Art

In canines, especially dogs exhibited in shows, owners complain that when the dogs receive certain commercial diets black hair turns to a reddish-brown color. These color changes have also been reported in dogs given therapeutic diets to treat disease conditions. Similar color changes occur with felines where a cat's hair becomes undesirably lighter or distorted in shade.

Over the last 30 years the nutrient requirements of cats, in particular, have been investigated, by the subject inventors. A study was conducted on the folic acid requirements of cats, and rather than use an all amino acid diet as a low folic acid diet, a diet based on gelatin as the protein source was used and supplemented it with amino acids. In the course of this study it was observed that the black cats' hair coat changed to reddish-brown. Several pilot experiments were conducted to exclude the involvement of the mineral component of the diets, particularly copper, since copper deficiency induces hair color changes, because copper is an integral part of the enzyme tyrosinase that catalyzes the conversion of tyrosine to dopamine and the oxidation of dopamine in the melanin pathway. Also, it was established that vitamins were not involved in the hair color degradation process.

The requirement of phenylalanine for growth of kittens was shown previously in studies with mixtures of pure, or free, amino acids, and indicated that tyrosine spares the need for phenylalanine. (Williams, J. M., J. G. Morris and Q. R. Rogers (1987) “Phenylalanine Requirement of Kittens and the Sparing Effect of Tyrosine,” Journal of Nutrition, 117:1102-1107). However, these were short term experiments and a change in hair color would not have been seen. Commercially available dog and cat diets have been known that are supplemented with pure methionine and lysine for nutritional reasons; however, neither phenylalanine nor tyrosine in pure, or free amino acid form, has been known to be an additive in commercial diets.

The foregoing information, along with any art submitted in any disclosure statement, reflects the state of the art of which the applicants are aware and is tendered with the view toward discharging applicants' acknowledged duty of candor in disclosing information which may be pertinent in the examination of this application. It is respectfully submitted, however, that this information does not teach or render obvious applicants' claimed invention.

### BRIEF SUMMARY OF THE INVENTION

An object of the present invention is to provide a food composition having sufficient levels of an amino acid that is essential for desirable hair coloration.

Another object of the present invention is to supply a food composition having levels of either tyrosine or phenylalanine or both that are sufficient for maintaining desirable hair coloration or reversing undesirable hair discoloration.

A further object of the present invention is to disclose a method for maintaining a desirable hair coloration in an animal or to reverse undesirable hair discoloration by means of adding one or more amino acid(s) to the animal's diet.

Still another object of the present invention is to relate a method for maintaining a desirable hair coloration in an animal or to reverse undesirable hair discoloration by means of supplementing the animal's diet directly with sufficient quantities of the amino acids tyrosine or phenylalanine, or both, or indirectly supplementing the animal's diet with peptides, polypeptides, proteins, and suitable derivatives thereof containing sufficient quantities of the amino acids tyrosine or phenylalanine, or both.

Yet a further object of the present invention is to describe a dietary regimen for alleviating or preventing hair discoloration, especially in animals, by utilizing appropriate levels of tyrosine or phenylalanine or both.

Disclosed is a consumable product utilized to maintain and restore hair (coat) color in animals. The product comprises a substrate (food, medicament, non-harmful inert support, and the like) and an effective amount of an amino acid (either the amino acid form, the direct form of the amino acid, or the amino acid derivable from alternate suitable sources such as peptides, polypeptides, proteins, and derivatives thereof such as amino acid acyl (like acetyl tyrosine or acetyl phenylalanine) or amide derivatives, the indirect form of the amino acid) selected from a group consisting of tyrosine and phenylalanine. The tyrosine and phenylalanine amino acids may be provided directly or in an indirect form such as in peptides, polypeptides, proteins, and acyl or amide derivatives that can be hydrolyzed (digested by the animal or by other appropriate means) into the suitable free amino acids, although the direct form is preferred. The effective amount of tyrosine (or, as indicated above, tyrosine derivable from alternate suitable sources such as peptides, polypeptides, proteins, and acyl and amide derivatives thereof) to be added to the diet is at least approximately 0.05% by weight and the effective amount of phenylalanine (or, as indicated above, phenylalanine derivable from alternate suitable sources such as peptides, polypeptides, proteins, and acyl and amide derivatives thereof) is at least approximately 0.10% by weight. It is believed that embodiments of the present invention may be used to maintain or restore hair coloration in human beings.

More preferably, since the about 9 g phenylalanine plus tyrosine per kg of cat food for cats, including adult cats and growing kittens, that is presently recommended as nutritionally adequate does not support full hair melanin synthesis by cats, use of an effective amount of a tyrosine source added to the amount present for nutritional requirements provides a confidence level that hair coloration will be maintained or, if discolored, will be restored. A particularly preferred embodiment of the invention is wherein a nutritionally adequate diet, with indirectly available amino acids, further includes, or has added, about 9 g of directly available phenylalanine, directly available tyrosine, or a combination of directly available phenylalanine and tyrosine per kg of diet. Thus, the total amount of available tyrosine may be about 18 g per kg, or more, to ensure that coat color is maintained or restored. A method using tyrosine and/or phenylalanine for maintaining and restoring hair color in an animal comprises the steps of adding an effective amount of an amino acid selected from a group consisting of tyrosine and phenylalanine to an animal consumable product to produce a supplemented consumable, and feeding an efficacious amount of the supplemented consumable to the animal to maintain and restore hair color.

Preferred embodiments of the present invention provide a method for maintaining or restoring hair color in a human being comprising administering to a human being a therapeutically effective amount of an amino acid selected from the group consisting of tyrosine, phenylalanine, and mixtures thereof. Preferred embodiments of the present invention also provide a composition for maintaining or restoring hair color in a human being comprising a therapeutically effective amount of an amino acid selected from the group consisting of tyrosine, phenylalanine, and mixtures thereof. The amino acid would be taken as a dietary supplement, and the therapeutic effective amount would depend on the weight and age of the human being, as well as the condition of the hair. Generally, the therapeutic effective amount of the amino acid for a person weighing from about 100 lbs. to about 200 lbs. may range from about 20 mg. to about 4000 mg., more typically from about 50 mg. to about 800 mg. The amino acid may be mixed with a substrate (e.g., a granulated substrate or the like) or a suitable filler material and/or a binder such that the dietary supplement for human beings may comprise the therapeutic effective amount plus filler material and/or a binder. The dietary supplement would be taken as often as needed, such as once or twice a day.

Preferred embodiments of the present invention also provide an animal consumable product utilized to maintain or restore hair color in the animal, comprising:

(a) a nutritionally adequate diet having at least one indirectly available amino acid (preferably a plurality of indirectly available amino acids) therein and

(b) an effective amount of a directly available amino acid selected from the group consisting of tyrosine, phenylalanine, and mixtures thereof. The effective amount of directly available tyrosine may be at least approximately 0.05% by weight of the diet. The effective amount of directly available phenylalanine may be at least approximately 0.10% by weight of the diet. The effective amount of directly available amino acid may also be about 9 g per kg of diet dry weight. Alternatively, the nutritionally adequate diet comprises more than about 0.80% by weight of indirectly available amino acid and/or more than about 0.70% by weight of directly available amino acid.

Additional preferred embodiments of the present invention provide a method for maintaining and restoring hair color in an animal, comprising the steps of:

(a) adding an effective amount (e.g., at least approximately 0.05% by weight, or at least approximately 0.10% by weight) of a directly available amino acid selected from the group consisting of tyrosine, phenylalanine and mixtures thereof or to an animal consumable product having indirectly available amino acids therein to produce a supplemented consumable; and

(b) feeding an efficacious amount of the supplemented consumable to the animal to maintain and restore hair color.

Further additional preferred embodiments of the present invention provide a method to allow expression of or to provide for the genetic potential of an animal for hair melanin (e.g., eumelanin or phaeomelanin) synthesis in the animal (e.g., a cat, a dog, or mink, etc.) comprising providing an animal having the capabilities of hair melanin synthesis; and feeding the animal a nutritional diet comprising more than about 0.50% by weight (e.g., more than about 1.65% by weight) of an amino acid selected from the group consisting of tyrosine, phenylalanine, and mixtures thereof, to maximize hair melanin synthesis in the animal.

The nutritional diet may comprise more than about 0.50% by weight of the amino acid, preferably from about 0.50% by weight to about 3.00% by weight of the amino acid, more preferably from about 1.00% by weight to about 3.00% by weight of the amino acid, most preferably from more than about 1.65% by weight to less than about 2.40% by weight of the amino acid, to allow expression of the genetic potential of animals for hair melanin synthesis in animals by maximizing hair melanin synthesis. The amino acid is preferably a bioavailable amino acid, which may be the degree to which an ingested amino acid in a particular source is absorbed in a form that can be utilized in metabolism by the animal. The nutritional diet may also comprise more than about 0.80% by weight of indirectly available amino acid. The nutritional diet may also comprise more than about 0.70% by weight of directly available amino acid. When the animal is a cat, the cat may be a full grown adult cat or a cat less than 1 year old, or less than 9 months, or even 6 months, such as a growing kitten.

In another preferred embodiment of the present invention there is provided a method to allow expression of, or to provide for, the genetic potential of an animal for hair melanin synthesis in the animal comprising:

feeding an animal (e.g., a cat, a dog, or mink, etc.) a nutritional diet comprising more than about 0.50% by weight of an amino acid selected from the group consisting of tyrosine, phenylalanine, and mixtures thereof, to provide for the genetic potential of the animal for hair melanin synthesis in the animal, by maximizing the hair melanin synthesis.

Further preferred embodiments of the present invention provide an animal (e.g., a cat, a dog, or mink, etc.) consumable product for maintaining or restoring hair color in an animal comprising a nutritionally adequate diet having more than about 0.80% by weight of at least one indirectly available amino acid, and more than about 0.70% by weight of an amino acid selected from the group consisting of tyrosine, phenylalanine, and mixtures thereof. At least one indirectly available amino acid may comprise an amino acid selected from the group consisting of tyrosine, phenylalanine, and mixtures thereof.

Other objects, advantages, and novel features of the present invention will become apparent from the detailed description that follows.

### DETAILED DESCRIPTION OF PREFERRED EMBODIMENTS OF THE INVENTION

Described below is a preferred embodiment of a desirable food and method of utilizing an amino acid, such as tyrosine and phenylalanine, in maintaining desirable hair coloration and reversing undesirable discoloration. It is to be understood that whenever tyrosine is referred to herein including the claims, it includes and means L-tyrosine, D-tyrosine, and mixtures of the two isomers (i.e., DL-tyrosine). Similarly, whenever phenylalanine is referred to herein including the claims, it includes and means L-phenylalanine, D-phenylalanine, and mixtures of the two isomers (i.e., DL-phenylalanine). When the amino acid is to be fed to an animal, the efficiency of utilization of the D isomer depends on the specie of the animal. Therefore, the amounts of the D-isomer and racemic mixture (i.e., D and L mixture) fed to any animal depend on the efficiency of utilization by the specie of the animal and the individual animal.

Hair color changes of animals, cats in particular, have been induced by using pure amino acid diets by adjusting the amount of phenylalanine and tyrosine in the diet. Also, it has been shown that supplementing a gelatin-based diet with tyrosine (or sufficiently high levels of phenylalanine) can prevent the hair color changes from occurring. It is noted that since phenylalanine can supply all the tyrosine that animals, such as rats need, phenylalanine is regarded as an essential amino acid and tyrosine a dispensable amino acid. Thus, in light of the current subject invention, at least in cats, it appears that at certain dietary concentrations of phenylalanine and tyrosine growth and apparent health are satisfactory, but there can be insufficient tyrosine for optimal or normal melanin synthesis and the hair of these cats contains lower levels of melanin than cats with sufficient tyrosine. The color alteration is most easily seen in black cats, but present for all colorations.

It is noted that animal tissue by-products which frequently contain high levels of collagen (with a low tyrosine content) are the basis of most pet foods (collagen is converted to gelatin on cooking). It is, therefore, not surprising that these foods contain lower levels of tyrosine than foods based on skeletal muscle and can result in animals having distorted hair colorations. Thus, the subject invention relates to the addition of tyrosine to animal diets, in particular to cat and dog diets, for the purpose of maintaining normal coat color. Obviously inclusion of a higher level of protein could accomplish the same ends, but protein is an expensive component of the diet and it is cost effective to use only a tyrosine supplement. Additionally, the addition of tyrosine containing peptides which contain a higher concentration of tyrosine than the protein that it was derived from supply the needed tyrosine. One possible inexpensive source of tyrosine is the oxidation of feathers or other proteinaceous material to produce a tyrosine concentrate of directly available tyrosine.

Therefore, a dietary product may be produced that includes sufficient tyrosine or phenylalanine or both to prevent and/or reverse hair color changes in animals. Also, a method of using sufficient levels of tyrosine or phenylalanine or both includes adding either or both of these amino acids in sufficient levels to produce the desired effect on hair coloration. Thus, inclusion of free or available tyrosine (either the amino acid form or the amino acid derivable, usually upon digestion or hydrolysis, from alternate suitable sources such as peptides, polypeptides, proteins, and acyl and amide derivatives thereof) at levels of about 0.05% by weight of diet matter (air dried) or greater and more preferably about 0.10% by weight of diet matter (air dried) or greater prevents hair color loss and restores lost hair color. Further, inclusion of free or available phenylalanine (either the amino acid form or the amino acid derivable from alternate suitable sources such as peptides, polypeptides, proteins, and acyl and amide derivatives thereof), with or without added tyrosine, at levels of about 0.10% and greater by weight of diet matter (air dried) and more preferably at levels of about 0.20% and greater by weight of diet matter (air dried) prevents hair color loss and restores lost hair color.

The amino acids (e.g., tyrosine and/or phenylalanine) are preferably bioavailable amino acids. Thus, the tyrosine and/or phenylalanine are preferably bioavailable tyrosine and/or bioavailable phenylalanine. Bioavailability may be defined as the degree to which an ingested nutrient in a particular source is absorbed in a form that can be utilized in metabolism by an animal. This means that bioutilization of the nutrient within normal metabolic processes of an animal establishes bioavailability. It is to be understood that not all of the bioavailable tyrosine and/or bioavailable phenylalanine which is ingested and absorbed in a form that can be utilized by an animal to allow expression of, or to provide for, the genetic potential of the animal for hair melanin synthesis in the animal, such as by maximizing the hair melanin synthesis. Thus, an animal may only use a portion of the bioavailable tyrosine and/or bioavailable phenylalanine for actually allowing expression of, or for providing, the genetic potential of the animal for hair melanin synthesis by maximizing hair melanin synthesis. Excess bioavailable phenylalanine and/or bioavailable tyrosine would simply be oxidized and used by an animal for energy. Therefore, even though a diet comprising from about 0.50% by weight to about 3.00% of a bioavailable amino acid (e.g., bioavailable phenylalanine and/or bioavailable tyrosine) is to be fed to an animal in order to provide for the genetic potential of the animal for hair melanin synthesis by maximizing melanin synthesis, much of this quantity of amino acid may be oxidized and used for energy, and is not actually employed for actually maximizing melanin synthesis. It is believed that the reason for this is because of competing enzymes which take the bioavailable phenylalanine and/or bioavailable tyrosine in two or more directions for two or more functions, with melanin synthesis having the least priority.

The amount of the bioavailable tyrosine and/or bioavailable phenylalanine which is oxidized and used by an animal for energy, instead of for optimizing or maximizing melanin synthesis, will depend on the particular animal, and on the physical conditions of any particular animal on any given day. For example, a sick or injured cat will use more of the bioavailable amino acid (i.e., the bioavailable tyrosine and/or bioavailable phenylalanine) for cure or healing purposes instead of for maximizing melanin synthesis purposes. We have discovered, however, that regardless of the physical condition of an animal, feeding an animal a diet comprising from about 0.50% by weight to about 3.00% by weight, preferably from about 1.00% by weight to about 3.00% by weight, more preferably from about 1.50% by weight to about 3.00% by weight (most preferably from more than about 1.65% by weight to less than about 2.40% by weight) of the bioavailable tyrosine and/or bioavailable phenylalanine as set forth below, to allow expression of, or to provide for, the genetic potential of an animal for hair melanin synthesis in the animal, such as by optimizing and/or maximizing melanin synthesis in the animal, regardless of the physical condition of the animal. The actual amount of the 0.50% by weight to 3.00% by weight of the bioavailable amino acid that is used for maximizing melanin synthesis and the amount used for energy may vary from animal to animal. It is believed that a low percentage of the bioavailable tyrosine and/or bioavailable phenylalanine as set forth herein, is used by an animal to maximize melanin synthesis. The actual percentage would depend on the species of animal; and, as previously indicated, for any particular animal the actual percentage would vary in accordance with the physiological state (growing, pregnant, maintenance, etc.) rate of hair growth and season of the year.

A combination of 4.5 g of phenylalanine plus 4.5 g of tyrosine per kg diet was recommended by the National Research Council (1986) as the minimal requirement for cats, especially growing kittens. These recommendations were based on the studies of Williams and others (1978) using growth rate and nitrogen balance in short (10 day) periods as the criteria of adequacy, which would not have detected any changes, in coat color. The most recent AAFCO (Association of American Feed Control Officials Publication 2000) Cat Food Nutrient Profile recommended 8.8 g/kg diet for phenylalanine plus tyrosine in cat food for both growing kittens and adult cats. However, while these recommendations apparently provide adequate nutrition, they do not satisfy our discovery that between about 16.5 g to about 24 g, more likely about 18 g, of tyrosine or phenylalanine or a combination of the two per kg dried diet is required to maintain or restore color. Commercially available diets, of course, typically exceed bare nutritional requirements, and at least some, perhaps many, commercial diets have sufficient tyrosine so as to maintain or restore coat color. This is shown in the following experimental section, Study 1A. However, in view of our discoveries described in this application, a preferred embodiment for practicing this invention is to supplement an otherwise nutritionally adequate diet with an effective amount of a tyrosine source to maintain coat color or restore coat color. The effective amount thus provides a confidence level that hair coloration will be maintained or, if discolored, that it will be restored. In one preferred embodiment the effective amount is about 9 g of one or both phenylalanine and tyrosine in direct, or free, form per kg diet.

### EXPERIMENTAL

Study 1A: Cats were first given a diet that changed their hair (coat) color to an “undesirable” shade (the diet having a low tyrosine composition) and then fed a second diet of a commercial dry cat food containing sufficient amino acids. The first diet-changed-coat-color (the “undesirable” shade) was restored back to its original black color after a time with the second diet. This study confirmed that hair color change in cats can be diet related. Also, the study showed that not only black, but orange colored cats and tabby patterned cats showed hair color changes.

Study 2A: The objective of this study was to identify where is the hair-color-changing factor, in the vitamin premix or the protein source for the diet mix. Three diets were made. They were CA (a gelatin based diet with a standard kitten vitamin premix used in the cat colony), CB (a negative control, casein and lactalbumin based diet with the same vitamin premix as CA and this diet did not change hair color according to unrelated studies), and CC (a positive control that was the same as CA, but with a different vitamin premix). Six black kittens for the same litter were used in this study to minimize any genetic influences. Both the CA and CC diets caused the hair color change. CB did not cause a hair color change. This indicated that the factor was in the protein source and that genetic influences were minimal. Samples of both original and color-changed hairs were observed under a microscope. Hypochromotrichia was found to be due to loss of melanin pigment in the hair shafts, which supported lack of tyrosine for melanin synthesis.

Study 2B: The objective of this further study was to confirm that the hair color change observed was related to the diet. To minimize possible genetic-treatment interactions, four black kittens from the same litter were used. They were given the casein-lactalbumin-based diet (Table 2) from weaning to 12 weeks of age; when they were divided into two groups. One group (one male and one female) continued to receive the casein-lactalbumin-based diet while the other group (two females) was given the gelatin-based diet. The casein-lactalbumin-based diet had been used in previous studies and no changes in hair coat color had been observed in cats. The gelatin-based diet was supplemented with amino acids and had a similar amino acid composition to the diet that caused the hair color change in the original cat. This diet contained all nutrients in sufficient amount for cats according to the recommendations of National Research Council (1986). Kittens received the diets for 4 months. The color of the hair of kittens given gelatin based diet changed from black to reddish-brown color, while kittens given the casein-lactalbumin diet maintained their black coat color. When hair samples were examined at a magnification of 100×, there were areas in the shafts from kittens given the gelatin diet that lacked pigment. No pigment loss was observed in hairs taken from the kittens given the casein-lactalbumin diet. These changes in hair color were first observed about a month after the kittens were given the gelatin diet. The color change first became apparent in the hair around the mouth, then the head, and progressed to the shoulder, forelegs, and the whole body. The newly grown hair in the shaved area was all reddish-brown and the change could be observed earlier than in unshaved area. Over about a three-month period, hair on the whole body changed color.

Study 3A: The objective of this study was to see if high dietary Pro, HOPro, Gly, or Arg amino acids observed in the hair color-changing diet contributed to the hair color change. This study utilized diet CB (negative control), CD (high Pro), CE (high HOPro), CF (high Gly), and CG (high Arg). CD, CE, CF, and CG were prepared by fortifying CB with the individual amino acids at the expense of starch. Five black kittens were used in this study. No loss of hair color was noted in any of the kittens. This study excluded high dietary Pro, HOPro, Gly, and Arg from factors that cause the hair color change.

Study 4A: The objective of this study was to confirm the hypothesis that tyrosine insufficiency caused the hair color change for cats. A diet that changed the color was prepared. The diet was divided into two equal portions with one portion fortified with crystalline tyrosine (diet CI, containing about 18 g/kg diet plus about 2 g/kg of background level) and the other portion having the same amount of starch (diet CH, used as a positive control since this diet caused hair color change). Four black kittens from different litters were used with two kittens in each group. The kittens given the CH diet had hair color changes and the kittens that received the CI diet (tyrosine fortified) did not have a hair color change.

Study 4B: Four black kittens of about 9 weeks of age from different litters were divided into two groups of two kittens (one male and one female) in each group. A single batch of gelatin diet was made and divided into two equal portions. To one portion, L-tyrosine was added to give a final tyrosine concentration of 19 g (16 g added and 3 g from the other dietary ingredients) per kg diet. To the other portion of the gelatin diet 16 g of starch was added per kg diet, resulting in a final tyrosine concentration of 3 g/kg diet. The kittens received either the gelatin diet without tyrosine supplementation or the gelatin diet with supplemental tyrosine for 11 weeks. Hair samples were taken from the lateral abdomen and photographs of each kitten were taken at the beginning and the end of the experiment. A 5 mL sample of blood was taken from the jugular vein of each kitten for analysis of amino acids using EDTA as an anticoagulant. All four kittens had similar black hair initially. The change in hair color of the two kittens given the gelatin diet from black to reddish-brown was similar to that observed in Study 1B. However, the two kittens given the gelatin diet supplemented with 16 g tyrosine/kg diet maintained their original black hair color. Total hair melanin and plasma tyrosine concentrations decreased in kittens given gelatin diet and were less than those in kittens given the gelatin diet supplemented with tyrosine (Table 1). The concentrations of tyrosine in plasma of the kittens given the gelatin diet were about one-fifth that of the kittens given the supplemental diet which was significantly different (p<0.02).

TABLE 1
Concentration of total melanin in hair and tyrosine in plasma
of kittens given the gelatin diet alone, or the gelatin diet
supplemented with tyrosine

| Diet | Gelatin | | Gelatin + tyrosine | |
|---|---|---|---|---|
| Kitten No. | 661 | 699 | 697 | 698 |
| Hair Total Melanin (g/g) | | | | |
| Initial | 0.10 | 0.15 | 0.13 | 0.22 |
| Final | 0.07 | 0.05 | 0.22 | 0.16 |
| Plasma Tyrosine (nmol/ml) | | | | |
| Final | 12 | 12 | 57 | 59 |

Study 5A: The objective of this study was to define the dose-response of hair color change to tyrosine and phenylalanine levels. Pure amino acid diets were used, as shown in Table 2. The kitten that received the diet free of tyrosine, but with 12 grams of phenylalanine showed hair color change. When the phenylalanine level was doubled to 24 grams no hair color change was observed, thereby confirming findings by others that as long as enough phenylalanine is in a diet tyrosine is not essential as phenylalanine can be converted into tyrosine in cats by a standard pathway.

TABLE 2
Amino acids diets used in hair color change, Study 5A*

| | | | | Diet P2 | | | Diet P5 | |
|---|---|---|---|---|---|---|---|---|
| Amino | | | Diet P1 | TYR + | Diet P3 | Diet P4 | TYR + | Diet P6 |
| Acid | ****Gelatin | NRC | PHE1 | PHE3 | PHE6 | PHE1 | PHE3 | PHE6 |
| TAU | 3.1 | 0.4 | 3 | 3 | 3 | 3 | 3 | 3 |
| ASP | 20.6 | | 20 | 20 | 20 | 20 | 20 | 20 |
| THR | 17 | | 20 | 20 | 20 | 20 | 20 | 20 |
| SER | 13.9 | | 15 | 15 | 15 | 15 | 15 | 15 |
| GLU | 37.8 | | 38 | 38 | 38 | 38 | 38 | 38 |
| GLY | 74 | | 75 | 67 | 55 | 77.5 | 71.5 | 59.5 |
| ALA | 38 | | 38 | 38 | 38 | 38 | 38 | 38 |
| VAL | 9.7 | 6 | 15 | 15 | 15 | 15 | 15 | 15 |
| MET | 1.1 | 4 + 3.5 | 10 | 10 | 10 | 10 | 10 | 10 |
| ILE | 7.5 | 5 | 12.5 | 12.5 | 12.5 | 12.5 | 12.5 | 12.5 |
| LEU | 17.6 | 12 | 30 | 30 | 30 | 30 | 30 | 30 |
| TYR | 2.6 | 4.5 | 4.5 | 4.5 | 4.5 | 0 | 0 | 0 |
| PHE | 9.5 | 4 | 4 | 12 | 24 | 6 | 12 | 24 |
| LYS | 15.4 | 8 | 20 | 20 | 20 | 20 | 20 | 20 |
| HIS | 3.8 | 3 | 7.5 | 7.5 | 7.5 | 7.5 | 7.5 | 7.5 |
| ARG | 25.8 | 10 | 25 | 25 | 25 | 25 | 25 | 25 |
| PRO | 34.2 | | 34 | 34 | 34 | 34 | 34 | 34 |
| TYP | | 1.5 | 3.75 | 3.75 | 3.75 | 3.75 | 3.75 | 3.75 |
| CYS | | 3.5 | 8.75 | 8.75 | 8.75 | 8.75 | 8.75 | 8.75 |
| Total | | | 384 | 384 | 384 | 384 | 384 | 384 |
| EAA** | | | 144 | 152 | 164 | 140 | 148 | 164 |
| DAA*** | | | 240 | 232 | 220 | 245 | 237 | 221 |
| EAA/DAA | | | 0.6 | 0.7 | 0.7 | 0.6 | 0.6 | 0.7 |

*All values are given as g/kg diet for air dried matter.
**EAA = essential amino acids
***DAA = dispensable amino acids
****Gelatin refers to the gelatin amino acid composition used in the diet that produced the original observed changes in hair color.

No hair changes were observed in the cat while given diet P1. The cat grew poorly on the diet and was transferred after 2 months to diet P3. Cats given diets P2 and P5 showed hair color changes. The cat given diet P4 developed facial lesions and was transferred to diet P5 which resulted in resolution of these lesions, but there were changes in the hair coat color. This experiment indicated the requirement for hair coat color maintenance is between 16.5 g and 24 g of available aromatic (i.e. tyrosine and phenylalanine) amino acids per kg dried diet.

Study 5B: The object of this experiment was to investigate whether phenylalanine alone or combined with tyrosine can prevent hair hypochromotrichia of cats. Four crystalline amino acid-based diets, AA1 through AA4 were prepared (Table 3). The amino acid profile of the four diets was the same with the exception of glycine, tyrosine, and phenylalanine. Glycine concentration in the diet was adjusted to accommodate the different dietary concentrations of tyrosine and phenylalanine. Four black kittens (3 males and 1 female) 10 to 12 weeks of age were randomly allocated to one of the four dietary treatments, which they received for 15 weeks. The female kitten was given diet AA2. Photographs of each kitten were taken at the beginning and the end of the experiment. Black hair changed to reddish-brown in the kitten given diet AA1 (4.5 g tyrosine, 12 g phenylalanine g/kg), and in the kitten given diet AA4 (tyrosine 0, phenylalanine 12 g/kg). Hair color remained black in the kitten given diet AA2 (tyrosine 4.5 g, phenylalanine 24 g/kg), and in the kitten given diet AA4 (tyrosine 0 g, phenylalanine 24 g/kg).

Study 5B demonstrated that the development of the reddish hair color in the black kitten was prevented by diet AA4 that contained 24 g phenylalanine/kg without tyrosine. However, the diet AA3 (12 g phenylalanine plus 0 tyrosine per kg) was inadequate to prevent the hair color change, indicating that this level of dietary phenylalanine, although known to support maximal nitrogen retention in growing kittens, did not supply sufficient tyrosine to the hair follicle for maximal melanin synthesis.

TABLE 3
Experiment Diets

| | | Casein- | | | | |
|---|---|---|---|---|---|---|
| Diets | Gelatin | Lactalbumin | AA1 | AA2 | AA3 | AA4 |
| Common | 484.7 | 484.7 | 484.7 | 484.7 | 484.7 | 484.7 |
| Ingredients* | | | | | | |
| Gelatin | 380 | | | | | |
| Casein | | 222.5 | | | | |
| Lactalbumin | | 222.5 | | | | |
| Amino acid | 40 | | | | | |
| mixture 1** | | | | | | |
| Amino acid | | | 297.5 | 297.5 | 297.5 | 297.5 |
| mixture 2*** | | | | | | |
| Glycine | | | 67 | 55 | 71.5 | 59.5 |
| L-tyrosine | | | 4.5 | 4.5 | 0 | 0 |
| L-phenylalanine | | | 12 | 24 | 12 | 24 |
| Taurine | 2.5 | 2.5 | 3 | 3 | 3 | 3 |
| Starch | 92.8 | 67.8 | 131.3 | 131.3 | 131.3 | 131.3 |

*Common ingredients were: animal fat (Florin Tallow, Dixon, CA), 300; sucrose, 100; mineral mixture (Williams and others. 1987), 50; cellulose, 20; vitamin mixture (Yu and Morris, 1997), 10; and choline chloride, 4.7.
**Amino acids (Ajinomoto U.S.A., Raleigh, NC) mixture 1 contained: L-isoleucine, 4.64; L-leucine, 7.32; L-methionine, 7.04; L-phenylalanine, 3.12; L-threonine, 3.72; L-tryptophan, 2.32; L-valine, 4.24; L-histidine, 3.20, and L-lysine · HCl, 4.40.
***Amino acid (Ajinomoto U.S.A., Raleigh, NC) mixture 2 contained: L-asparagine, 20; L-threonine, 20; L-serine, 15; L-glutamine, 38; L-alanine, 38; L-valine, 15; L-methionine, 10; L-isoleucine, 12.5; L-leucine, 30; L-lysine, 20; L-histidine, 7.5; L-arginine, 25; L-proline, 34; L-tryptophan, 3.75; and L-cystine, 8.75.

Study 6A: The objective of this study was to investigate if a hair-color-changing diet also caused hair color change of newborn kittens (fetus). The breeding was initiated and two queens (both black) that had been on diet CA for at least two months were used. All kittens (all black) born to the two queens had hair color changed. This result demonstrated that tyrosine insufficiency also affects fetus and newborn kittens.

Study 6B: Two black queens were given gelatin diet for three months, which produced a change in the queen's hair color from black to reddish-brown. An adult black tom that had previously been consuming a commercial dry cat food was exposed to the queens for about a month during which period he also received gelatin diet. Both queens went to full term and produced one and two live kittens. The litter size was smaller than the colony average but both were first litter queens. All three kittens were apparently normal at birth except that their hair color, which should have been black, was reddish-brown. When the kittens were about 8 weeks of age, most of the hair was black with some reddish-brown hairs still visible because queen milk contains proteins supplying adequate amounts of phenylalanine and tyrosine for melanin synthesis.

In sum, the requirement for maximal melanin synthesis is therefore greater than a combination of 12 g L-phenylalanine plus 4.5 g L-tyrosine but less than 24 g L-phenylalanine alone. Furthermore, commercial diets containing a total aromatic amino acid (i.e., phenylalanine and/or tyrosine) concentration of about 23 g/kg (e.g., having about 45% tyrosine in the concentration) maintained black hair color in cats of all ages. These concentrations were much greater than those required for either maximal nitrogen balance or weight gain. We are unaware of any other examples where the need for a dispensable amino acid to support a secondary function is so much greater (about twice) than that for nitrogen balance or maximal growth. Because there is such a striking difference between a nutritionally adequate amount of phenylalanine plus tyrosine and the amount of tyrosine, or source of tyrosine, to maintain hair color, the supplementation of even nutritionally adequate commercial diet becomes quite desirable if coat color is considered important by the pet's owner.

By the practice of preferred embodiments of the present invention there is provided an animal consumable product utilized to maintain or restore hair color in the animal. One preferred embodiment includes a nutritionally adequate diet having at least one indirectly available amino acid (preferably a plurality of indirectly available amino acids) therein and an effective amount of a directly available amino acid selected from the group consisting of tyrosine, phenylalanine, and mixtures thereof. The effective amount of directly available tyrosine may be at least approximately 0.05% by weight of the diet. The effective amount of directly available phenylalanine may be at least approximately 0.10% by weight of the diet. The effective amount of directly available amino acid may more specifically be about 9 g per kg of diet dry weight. Alternatively, the nutritionally adequate diet comprises more than about 0.80% by weight of indirectly available amino acid and/or more than about 0.70% by weight of directly available amino acid.

By the further practice of the present invention additional preferred embodiments of the present invention, there is provided a method for maintaining and restoring hair color in an animal, comprising the steps of adding an effective amount (e.g., at least approximately 0.05% by weight, or at least approximately 0.10% by weight) of a directly available amino acid selected from the group consisting of tyrosine, phenylalanine and mixtures thereof or to an animal consumable product having indirectly available amino acids therein to produce a supplemented consumable; and feeding an efficacious amount of the supplemented consumable to the animal to maintain and restore hair color.

Further practice of additional preferred embodiments of the present invention provide a method to allow expression of, or to provide for, the genetic potential of an animal for hair melanin synthesis in the animal, such as by maximizing hair melanin synthesis in the animal (e.g., a cat, a dog, or mink, etc.) by feeding the animal a nutritional diet comprising more than about 0.50% by weight of an amino acid selected from the group consisting of tyrosine, phenylalanine, and mixtures thereof to commence maximizing hair melanin synthesis in the animal. The nutritional diet may contain from about 0.50% by weight to about 3.00% by weight of the amino acid, preferably from about 1.00% by weight to about 3.00% by weight, more preferably from more than about 1.65% by weight to less than about 2.40% by weight of the amino acid for maximizing the hair melanin synthesis in the animal. The nutritional diet may also contain more than about 0.80% by weight of indirectly available amino acid. The nutritional diet may also contain more than about 0.70% by weight of directly available amino acid. As previously indicated, the animal may be any animal, such as a cat. In one embodiment of the invention, when the animal is a cat, the cat may be a full grown adult cat, or a cat less than 1 year old, less than 9 months old, or even less than 6 months old, such as a growing kitten.

Alternative preferred embodiments of the present invention provide a method for allowing expression, or for providing for, the genetic potential of an animal for hair melanin synthesis in the animal, by maximizing hair melanin synthesis in the animal. The method includes, as previously indicated, feeding an animal (e.g., a cat, a dog, or mink, etc.) a nutritional diet comprising more than about 0.50% by weight of an amino acid selected from the group consisting of tyrosine, phenylalanine, and mixtures thereof for maximizing hair melanin synthesis in the animal. Further alternative preferred embodiments of the present invention provide an animal (e.g., a cat, a dog, or mink, etc.) consumable product for maintaining or restoring hair color in an animal comprising a nutritionally adequate diet having more than about 0.80% by weight of at least one indirectly available amino acid, and more than about 0.70% by weight of an amino acid selected from the group consisting of tyrosine, phenylalanine, and mixtures thereof. As also previously indicated at least one indirectly available amino acid may comprise an amino acid selected from the group consisting of tyrosine, phenylalanine, and mixtures thereof.

The invention has now been explained with reference to specific embodiments. Other embodiments will be suggested to those of ordinary skill in the appropriate art upon review of the present specification. While it is to be understood that the invention has been described above in conjunction with preferred specific embodiments, the description and examples are intended to illustrate and not limit the scope of the invention. Thus, while the present invention has been described herein with reference to particular embodiments thereof, a latitude of modification, various changes and substitutions are intended in the foregoing disclosure, and it will be appreciated that in some instances some features of the invention will be employed without a corresponding use of other features without departing from the scope and spirit of the invention as set forth. For example, it is anticipated that embodiments of the present invention may be employed to maintain or restore hair coloration in human beings, when a therapeutic effective amount (e.g., from about 20 mg. to about 4000 mg., more typically from about 50 mg. to about 800 mg.) of tyrosine, phenylalanine, and mixtures thereof, are administered to a human being as often as needed, say once or twice a day until healthy hair with appropriate coloration is obtained. Therefore, many modifications may be made to adapt a particular situation or material to the teachings of the invention without departing from the essential scope and spirit of the present invention. It is intended that the invention not be limited to the particular embodiment disclosed as the best mode contemplated for carrying out this invention, but that the invention will include all embodiments and equivalents falling within the scope of the appended claims.

What is claimed is:

1. An animal consumable product utilized to maintain or restore hair color in the animal, comprising:
(a) a nutritionally adequate diet having at least one indirectly available amino acid therein and
(b) an effective amount of a directly available amino acid selected from the group consisting of tyrosine, phenylalanine and mixtures thereof.

2. A product according to claim 1, wherein said effective amount of directly available tyrosine is at least approximately 0.05% by weight of the diet.

3. A product according to claim 1, wherein said effective amount of directly available phenylalanine is at least approximately 0.10% by weight of the diet.

4. A product according to claim 1, wherein said effective amount of directly available amino acid is about 9 g per kg of diet dry weight.

5. A method for maintaining and restoring hair color in an animal, comprising the steps of:
(a) adding an effective amount of a directly available amino acid selected from the group consisting of tyrosine, phenylalanine and mixtures thereof to an animal consumable product having at least one indirectly available amino acid therein to produce a supplemented consumable; and
(b) feeding an efficacious amount of said supplemented consumable to the animal to maintain and restore hair color.

6. A method according to claim 5, wherein said effective amount of directly available tyrosine is at least approximately 0.05% by weight.

7. A method according to claim 5, wherein said effective amount of directly available phenylalanine is at least approximately 0.10% by weight.

8. A method of providing for the genetic potential of a cat for hair melanin synthesis in the cat by maximizing the hair melanin synthesis comprising:
providing a cat having the capabilities of hair melanin synthesis; and
feeding the cat a nutritional diet comprising more than about 0.50% by weight of an amino acid selected from the group consisting of tyrosine, phenylalanine, and mixtures thereof to maximize hair melanin synthesis in the cat.

9. A method of claim 8 wherein said nutritional diet comprises from more than about 1.65% by weight to less than about 2.40% by weight of said amino acid to maximize the hair melanin synthesis in said cat.

10. A method of claim 8 wherein said nutritional diet comprises more than about 0.80% by weight of indirectly available amino acid.

11. A method of claim 9 wherein said nutritional diet comprises more than about 0.80% by weight of indirectly available amino acid.

12. A method of claim 8 wherein said nutritional diet comprises more than about 0.70% by weight of directly available amino acid.

13. A method of claim 9 wherein said nutritional diet comprises more than about 0.70% by weight of directly available amino acid.

14. A method of claim 10 wherein said nutritional diet additionally comprises more than about 0.70% by weight of directly available amino acid.

15. A method of claim 11 wherein said nutritional diet additionally comprises more than about 0.70% by weight of directly available amino acid.

16. A method of claim 8 wherein said amino acid comprises a mixture of phenylalanine and tyrosine.

17. A method of claim 9 wherein said amino acid comprises a mixture of phenylalanine and tyrosine.

18. A method of claim 10 wherein said amino acid comprises a mixture of phenylalanine and tyrosine.

19. A method of claim 11 wherein said amino acid comprises a mixture of phenylalanine and tyrosine.

20. A method of claim 12 wherein said amino acid comprises a mixture of phenylalanine and tyrosine.

21. A method of claim 13 wherein said amino acid comprises a mixture of phenylalanine and tyrosine.

22. A method of claim 14 wherein said amino acid comprises a mixture of phenylalanine and tyrosine.

23. A method of claim 15 wherein said amino acid comprises a mixture of phenylalanine and tyrosine.

24. A method of claim 8 wherein said amino acid comprises phenylalanine.

25. A method of claim 9 wherein said amino acid comprises phenylalanine.

26. A method of claim 8 wherein said cat is less than about 1 year old.

27. A method of claim 9 wherein said cat is an adult cat.

28. A product according to claim 1, wherein said nutritionally adequate diet comprises more than about 0.80% by weight of indirectly available amino acid.

29. A product according to claim 1, wherein said directly available amino acid comprises more than about 0.70% by weight of said nutritionally adequate diet.

30. A method of allowing expression of the genetic potential of an animal for hair melanin synthesis in the animal by maximizing the hair melanin synthesis comprising:
feeding an animal a nutritional diet comprising more than about 0.50% by weight of an amino acid selected from the group consisting of tyrosine, phenylalanine, and mixtures thereof, for maximizing hair melanin synthesis in the animal.

31. An animal consumable product for maintaining or restoring hair color in an animal comprising a nutritionally adequate diet having more than about 0.80% by weight of at least one indirectly available amino acid and more than about 0.70% by weight of a directly available amino acid selected from the group consisting of tyrosine, phenylalanine, and mixtures thereof.

32. An animal consumable product according to claim 31 wherein said at least one indirectly available amino acid comprises an amino acid selected from the group consisting of tyrosine, phenylalanine, and mixtures thereof.

33. A method of allowing expression of the genetic potential of an animal for hair melanin synthesis in the animal by maximizing the hair melanin synthesis comprising:
feeding an animal a nutritional diet comprising from about 0.50% by weight to about 3.00% by weight of a bioavailable amino acid selected from the group consisting of tyrosine, phenylalanine, and mixtures thereof, for maximizing hair melanin synthesis in the animal.

34. An animal consumable product for maintaining or restoring hair color in an animal comprising a nutritionally adequate diet comprising from about 0.50% by weight to about 3.00% by weight of a bioavailable amino acid selected from the group consisting of tyrosine, phenylalanine, and mixtures thereof, which when consumed by an animal maximizes hair melanin synthesis in the animal.

35. A method for maintaining or restoring hair color in a human being comprising administering to a human being a therapeutically effective amount of an amino acid selected from the group consisting of tyrosine, phenylalanine, and mixtures thereof.

36. A composition for maintaining or restoring hair color in a human being comprising a therapeutically effective amount of an amino acid selected from the group consisting of tyrosine, phenylalanine, and mixtures thereof.
